(19) United States
(12) Patent Application Publication
(10) Pub. No.: US 2026/0302302 A1
(43) Pub. Date: Oct. 1, 2026

(54) FUEL CELL AND FUEL CELL SYSTEM

(71) Applicant: HONDA MOTOR CO., LTD., TOKYO (JP)

(72) Inventor: Shota FUJIMURA, WAKO-SHI (JP)

(21) Appl. No.: 19/629,404

(22) Filed: Mar. 26, 2026

(30) Foreign Application Priority Data
Mar. 28, 2025 (JP) 2025-055604

(51) Int. Cl. H01M 8/2475; H01M 8/0438

(52) U.S. Cl. CPC H01M 8/2475; H01M 8/04388

(57) ABSTRACT

The fuel cell includes a hydrogen-capture hood covering an upper part of a hydrogen-system auxiliary device section adjacent to a stack case, and a hydrogen sensor. The hydrogen-capture hood includes an upper end wall forming an uppermost portion, a sidewall extending downward from a peripheral edge of the upper end wall, and an discharge hole spaced downward from the upper end wall, and the hydrogen sensor is arranged inside the hydrogen-capture hood at a level higher than the discharge hole without protruding upward from the upper end wall.

### CROSS-REFERENCE TO RELATED APPLICATIONS

This application is based upon and claims the benefit of priority from Japanese Patent Application No. 2025-055604 filed on March 28, 2025, the contents of which are incorporated herein by reference.

### BACKGROUND OF THE INVENTION

### Field of the Invention

The present disclosure relates to a fuel cell and a fuel cell system.

### Description of the Related Art

In recent years, research and development have been conducted on fuel cells that contribute to energy efficiency in order to ensure that more people have access to affordable, reliable, sustainable and modern energy.

### SUMMARY OF THE INVENTION

In the art relating to fuel cells, there is a demand for improved usability as a general-purpose product that can be used not only in passenger cars but also in various application devices such as trucks and stationary power sources. In order to satisfy the usability as a general-purpose product, it is conceivable to accommodate the fuel cell and its auxiliary equipment in a rectangular parallelepiped box-shaped region (envelope) having a predetermined dimension agreed with manufacturers of application devices.

On the other hand, JP 2024-089946 A discloses collecting and discharging structure provided at an upper portion of a box-shaped container for collecting and discharging hydrogen, and attaching a hydrogen sensor in the vicinity of a portion from which hydrogen is discharged. However, such a structure to which a hydrogen sensor is attached requires a space for attachingthe hydrogen sensor in the upper portion, and the hydrogen sensor bulges upward from the box-shaped container. In the case where such upward bulging is spatiallyrestrictedin view of therequirement that auxiliary devices needbe accommodated within a predetermined region, the above technique causes a difficulty in attaching the hydrogen sensor.

Therefore, there is a demand for a structure that is capable of attaching a hydrogen sensor to a position where hydrogen can be efficiently detected even when there is a spatial restriction in the upper portion.

The present disclosure has the object of solving the aforementioned problem.

A first aspect of the present disclosure is a fuel cell including: a stack case that houses a fuel cell stack; a hydrogen-system auxiliary device section that is provided adjacent to the stack case and in which auxiliary devices configured to supply hydrogen to the fuel cell stack are collectively disposed; a hydrogen-capture hood that is provided to cover an upper portion of the hydrogen-system auxiliary device section and that opens downward; and a hydrogen sensor that is attached to the hydrogen-capture hood, wherein the hydrogen-capture hood includes an upper end wall forming an uppermost portion, a sidewall extending downward from a peripheral edge of the upper end wall, and a discharge hole disposed at the sidewall at a position separated downwardly from the upper end wall and configured to discharge hydrogen captured on an inner side ofthe sidewall, and wherein the hydrogen sensor is arranged inside the hydrogen-capture hood so as not to protrude above the upper end wall, and is positioned at a level higher than the discharge hole.

A second aspect of the present disclosure is a fuel cell system including two of the fuel cells according to the first aspect, wherein the hydrogen-system auxiliary device section of a first fuel cell, which is one of the two of the fuel cells, and the hydrogen-system auxiliary device section of a second fuel cell, which is another of the two of the fuel cells, are disposed so as to face each other, and the hydrogen-capture hood covers the hydrogen-system auxiliary device section of the first fuel cell and the hydrogen-system auxiliary device section of the second fuel cell from above.

According to the present disclosure, even when there is a spatial restriction in the upper portion, the hydrogen sensor can be disposed at a position where hydrogen can be efficiently detected, and hydrogen leakage from the auxiliary devices can be reliably detected.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a fuel cell according to a first embodiment;

FIG. 2 is a perspective view of the hydrogen-capture hood shown in FIG. 1;

FIG. 3 is a cross-sectional view of the hydrogen-capture hood taken along line III-III of FIG. 2;

FIG. 4 is an enlarged cross-sectional view of a main part taken along line IV-IV of FIG. 1;

FIG. 5 is an explanatory diagram of operations of the fuel cell of FIG. 1; and

FIG. 6 is a schematic configuration diagram of a fuel cell system according to the second embodiment.

### DETAILED DESCRIPTION OF THE INVENTION

### First Embodiment

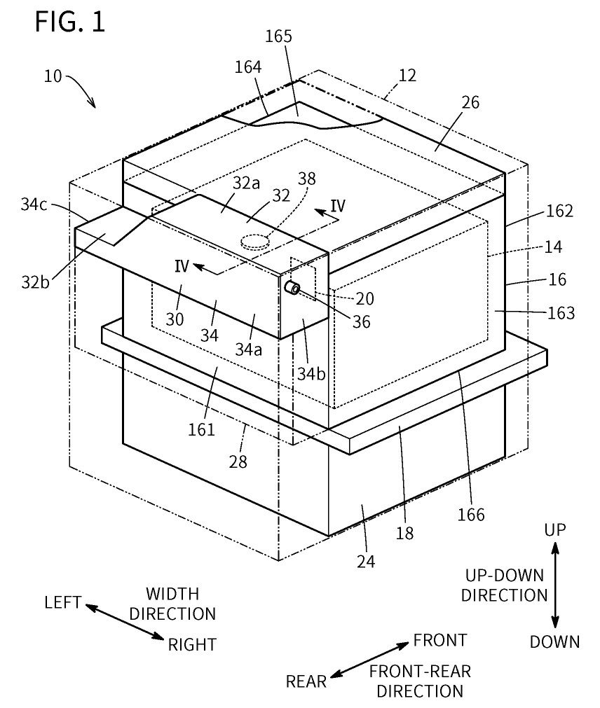

A fuel cell 10 of the present embodiment shown in FIG. 1 is mounted on a moving object such as a truck, a trailer head, a civil engineering/construction machine, an aircraft, a ship, and the like, or is used as a stationary backup power source or the like of a facility that consumes a large amount of electrical power such as a data center. In order to facilitate mounting of the fuel cell 10 on a wide range of devices, all components including auxiliary devices, pipes, and wires are housed in a rectangular parallelepiped region called an envelope 12. The arrangement of the auxiliary devices of the fuel cell 10 is restricted by the envelope 12.

The fuel cell 10 includes a stack case 16 that houses a fuel cell stack 14, a frame 18 that supports the stack case 16, and the auxiliary devices. The stack case 16 is a box-shaped container having a substantially rectangular parallelepiped shape extending in the front-rear direction, the width direction, and the up-down direction. The front-rear direction, the width direction, and the up-down direction are mutually orthogonal. The front-rear direction and the width direction are terms used to indicate the arrangement relationship of the respective members of the fuel cell 10, and do not limit the arrangement direction of the fuel cell 10. The up-down direction substantially coincides with the vertical direction.

The stack case 16 has a first sidewall 161, a second sidewall 162, a third sidewall 163, a fourth sidewall 164, an upper wall 165, and a bottom wall 166. The first sidewall 161 is positioned rearward in the front-rear direction, and the second sidewall 162 is positioned forward in the front-rear direction. The third sidewall 163 is positioned on the right side in the width direction, and the fourth sidewall 164 is positioned on the left side in the width direction.

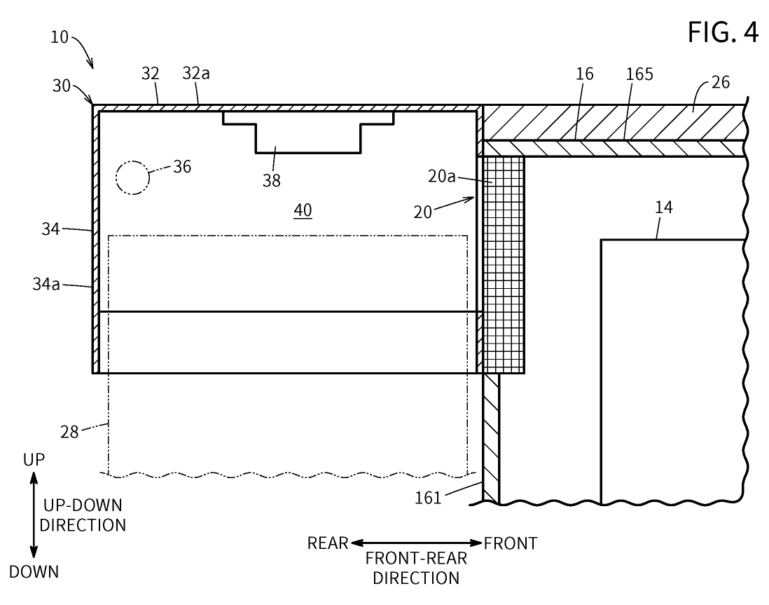

The stack case 16 accommodates the fuel cell stack 14 therein, thereby limiting the location from which hydrogen leaked from the fuel cell stack 14 flows out. Hydrogen leaked from the fuel cell stack 14 and its peripheral pipes, flow paths, and the like accumulates in an upper region of the stack case 16. In order to discharge the leaked hydrogen, the stack case 16 has a ventilation unit 20. The ventilation unit 20 is disposed near the upper end of the first sidewall 161. As shown in FIG. 4, the ventilation unit 20 includes a filter 20a for preventing water droplets and dust from entering from the outside.

As shown in FIG. 1, the stack case 16 is disposed on the frame 18. The frame 18 has a larger width than the stack case 16. A fixing mechanism (not shown) for fixing the stack case 16 to the frame 18 is provided on a side portion of the frame 18 in the width direction. In addition to the stack case 16, some auxiliary devices and the like are fixed to the frame 18. The frame 18 may also be used as a fixing portion for attaching the fuel cell 10 to an external device.

The fuel cell 10 includes hydrogen-system auxiliary devices, air-system auxiliary devices, and an electrical system as auxiliary devices.

The air-system auxiliary devices include an air pump that compresses air, a heat exchanger that cools the compressed air, a humidifier that humidifies the compressed air, an air pipe that connects these components, an exhaust pipe through which the cathode off-gas flows, and valves provided in the respective components. In order to prevent the pipes from being elongated, the air-system auxiliary devices are collectively arranged in the air-system auxiliary device section 24. The air-system auxiliary device section 24 is provided below the frame 18.

The electrical system includes a high voltage power circuit, a low voltage power circuit, and a controller. The high-voltage power circuit constitutes a power supply device that converts the electrical power generated by the fuel cell stack 14 into a predetermined voltage and outputs the predetermined voltage. The low-voltage power circuit constitutes a power supply device that supplies direct current power of a relatively low voltage such as 12V, 24V, 48V, or the like, which is necessary for driving the controller, the valves, the sensors, and the like. The high-voltage power circuit and the low-voltage power circuit include heat-generating components, and are therefore provided on the upper wall 165 of the stack case 16. The high-voltage power circuit and the low-voltage power circuit are collectively disposed in a power circuit section 26 above the stack case 16. Although not particularly shown, the controller is disposed on a side of the second sidewall 162 away from the hydrogen-system auxiliary device section 28.

The hydrogen-system auxiliary devices include, for example, a high-pressure hydrogen pipe, a hydrogen circulation pipe, a gas-liquid separator, a hydrogen pump (for example, a jet pump type ejector), an electromagnetic valve (injector) that blows hydrogen in a high-pressure hydrogen pipe into the hydrogen circulation pipe, and valves. In order to prevent the hydrogen circulation pipe and the high-pressure hydrogen pipe from being elongated, the hydrogen-system auxiliary devices are collectively arranged in the hydrogen-system auxiliary device section 28. The hydrogen-system auxiliary device section 28 is provided on theside (rear side) of the first sidewall 161 of the stack case 16.

In the hydrogen-system auxiliary devices, hydrogen leaks little by little through pipes, valves, outer walls of the auxiliary devices, and the like. In addition, leakage of hydrogen increases due to defects such as looseness of connecting portions of the pipes, valves, and auxiliary devices or cracks due to deterioration. The fuel cell 10 of the present embodiment includes a hydrogen-capture hood 30 in order to efficiently detect leakage of hydrogen from the hydrogen-system auxiliary devices.

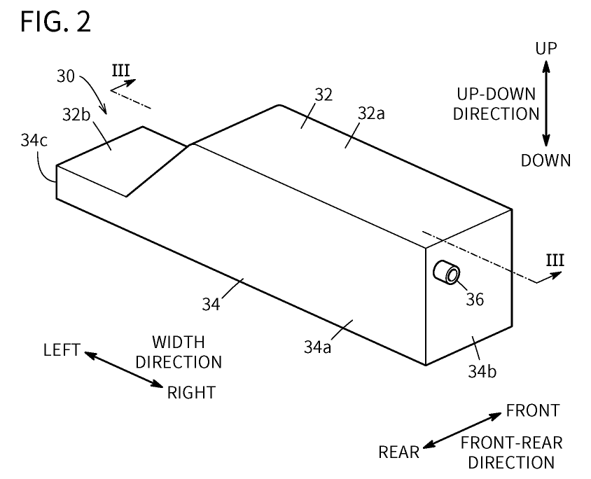

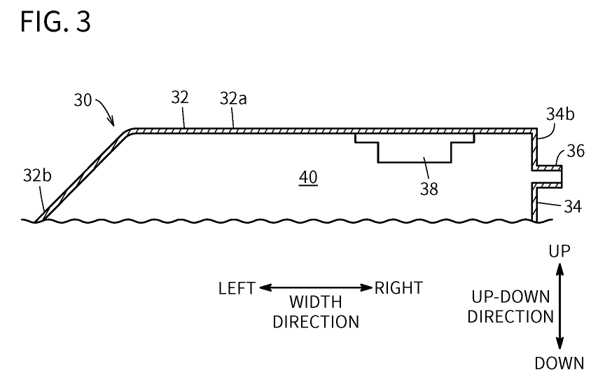

The hydrogen-capture hood 30 is attached to the first sidewall 161 of the stack case 16, and is disposed so as to cover the hydrogen-system auxiliary device section 28 from above. As shown in FIGS. 2 to 4, the hydrogen-capture hood 30 includes an upper end wall 32, a sidewall 34, a discharge hole 36, and a hydrogen sensor 38.

The upper end wall 32 defines an upper part of the hydrogen-capture hood 30. The upper end wall 32 includes an uppermost portion 32a and a recessed portion 32b that is recessed downward partially in the width direction. The uppermost portion 32a is the highest portion of the hydrogen-capture hood 30. The uppermost portion 32a is positioned in the vicinity of the upper end of the envelope 12. The uppermost portion 32a is positioned at substantially the same level as the upper end of the power circuit section 26. Wires and connectors to be connected to the power circuit section 26 may be disposed in the recessed portion 32b. However, depending on the design of the power circuit section 26, the hydrogen-capture hood 30 may not be provided with the recessed portion 32b.

The sidewall 34 extends downward from the peripheral edge of the upper end wall 32. The sidewall 34 includes a rear sidewall 34a, a right sidewall 34b, and a left sidewall 34c. The rear sidewall 34a is positioned at the rear end of the hydrogen-capture hood 30. The rear sidewall 34a is positioned in the vicinity of the rear end of the envelope 12. The right sidewall 34b is positioned at the right end of the hydrogen-capture hood 30 in the width direction. The right sidewall 34b is positioned in the vicinity of the right end of the envelope 12. The left sidewall 34c is positioned at the left end of the hydrogen-capture hood 30 in the width direction. The left sidewall 34c is positioned in the vicinity of the left end of the envelope 12. The sidewall 34 includes an opening at a position facing the ventilation unit 20 of the stack case 16 so as not to block the ventilation unit 20. The sidewall 34 extending downward from the peripheral edge of the upper end wall 32 of the hydrogen-capture hood 30 forms a hydrogen-capture chamber 40 beneath the upper end wall 32. The upper end wall 32 and the sidewall 34 are disposed so as to cover the ventilation unit 20 from above, and can guide hydrogen discharged from the ventilation unit 20 to the hydrogen sensor 38.

In the case where the hydrogen captured in the hydrogen-capture chamber 40 reaches a predetermined concentration, the captured hydrogen is discharged to the outside through the discharge hole 36. The discharge hole 36 is formed in the right sidewall 34b farthest from the recessed portion 32b. The hydrogen captured below or near the recessed portion 32b flows toward the right sidewall 34b owing to the difference in height between the recessed portion 32b and the upper end wall 32, and flows out to the outside through the discharge hole 36. By arranging the discharge hole 36 on the right sidewall 34b, hydrogen can be accumulated around the hydrogen sensor 38.

The discharge hole 36 is provided at a position spaced downward from the upper end wall 32. Thus,in the hydrogen-capture chamber 40 a region where hydrogen tends to accumulate is formed in the portion above the discharge hole 36. Thus, even when the amount of leakage of hydrogen is small, hydrogen can be guided to the hydrogen sensor 38.

Further, by providing the discharge hole 36 on the right sidewall 34b, it is possible to prevent water, gravel, and the like from entering from above, which is preferable. The discharge hole 36 is disposed on the right sidewall 34b at a position closer to the rear end. Since the discharge hole 36 is disposed closer to the rear end, the hydrogen sensor 38 is positioned between the discharge hole 36 and the ventilation unit 20. This prevents the hydrogen having flowedout of the ventilation unit 20 from flowing to the outside without passing by the hydrogen sensor 38.

The hydrogen sensor 38 is attached to the lower surface of the uppermost portion 32a of the upper end wall 32. The hydrogen sensor 38 bulges downward from the uppermost portion 32a without protruding upward from the upper end wall 32. Therefore, even in the case where the upper end of the envelope 12 restricts the space to such an extent that upward installation of the hydrogen sensor 38 is not feasible, the hydrogen sensor 38 can nevertheless be attached.

The hydrogen sensor 38 is disposed in the vicinity of the right sidewall 34bin the width direction, that is,near the discharge hole 36, and at least a detection portion for detecting hydrogen is arranged above the discharge hole 36. Thus, hydrogen accumulates in the hydrogen-capture chamber 40. If the amount of hydrogen accumulated in the hydrogen-capture chamber 40 is so small as it can be in a normal state, hydrogen is not detected by the hydrogen sensor 38, and is diffused into the atmosphere through the lower opening of the hydrogen-capture chamber 40 and the discharge hole 36, and the concentration of the hydrogen is reduced. However, in a case where hydrogen leakage occurs at a flow rate that causes the concentration of hydrogen reaches a predetermined concentration inside the hydrogen-capture chamber 40, the hydrogen sensor 38 detects the hydrogen leakage. Even in this case, since the hydrogen in the hydrogen-capture chamber 40 flows out quickly through the discharge hole 36, the hydrogen of the predetermined concentration does not stay in the hydrogen-capture chamber 40 for a long period of time.

As shown in FIG. 4, the hydrogen sensor 38 is disposed at a position closer to the ventilation unit 20 than the discharge hole 36. Thus, the hydrogen leaked from the fuel cell stack 14 and flowing through the ventilation unit 20 is discharged from the discharge hole 36 after contacting the hydrogen sensor 38, so that the hydrogen sensor 38 can reliably detect the hydrogen leaking from the ventilation unit 20.

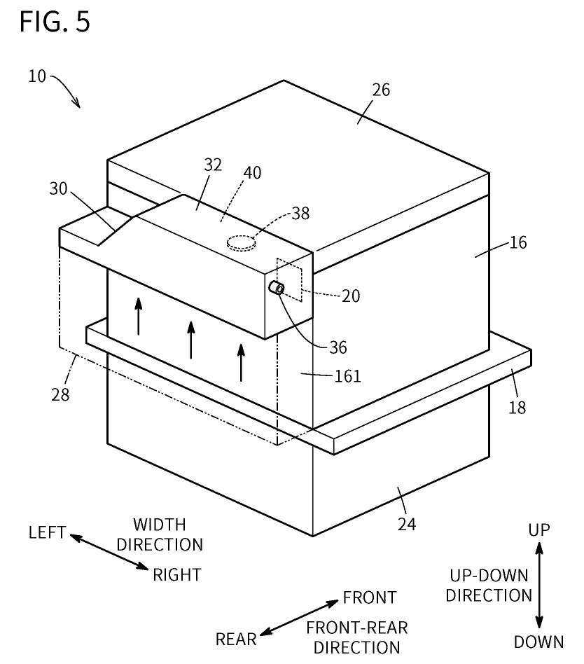

The fuel cell 10 of the present embodiment is configured as described above. As shown in FIG. 5, the hydrogen leaking from any part of the hydrogen-system auxiliary device section 28 flows upward and accumulates in the hydrogen-capture hood 30. The hydrogen captured by the hydrogen-capture hood 30 accumulatesin the upper part of the hydrogen-capture chamber 40, and when the concentration of the hydrogen reaches a predetermined concentration or more, the hydrogen is detected by the hydrogen sensor 38. Since the hydrogen accumulated in the hydrogen-capture chamber 40 is discharged through the discharge hole 36, it is possible to prevent the occurrence of a phenomenon in which hydrogen having a concentration equal to or higher than a predetermined concentration continues to remain in the hydrogen-capture chamber 40 for a long period of time.

### Second Embodiment

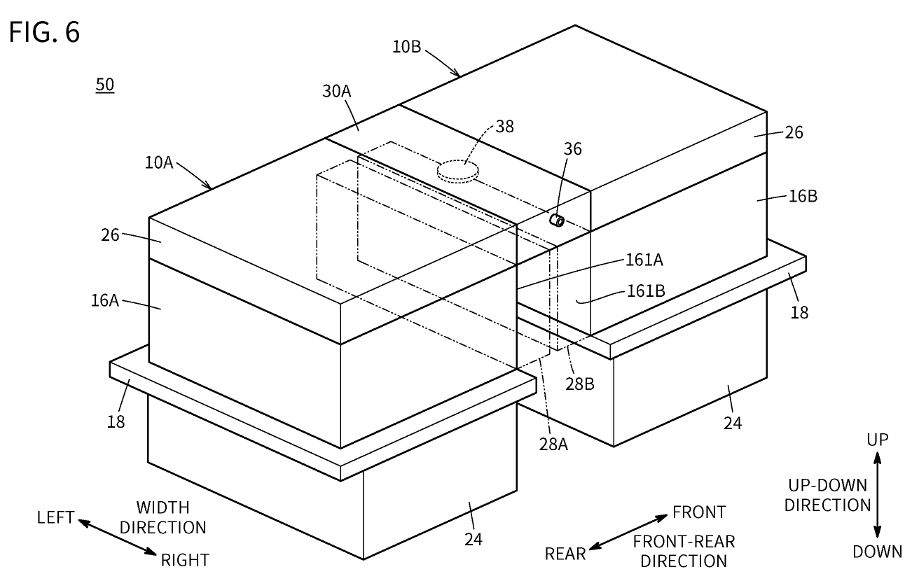

As shown in FIG. 6, the fuel cell system 50 of the present embodiment includes two fuel cells 10. One of the two fuel cells 10 is referred to as a first fuel cell 10A, and the other of the two fuel cells 10 is referred to as a second fuel cell 10B. The first fuel cell 10A and the second fuel cell 10B are configured in the same manner as the fuel cell 10 described with reference to FIG. 1. In the first fuel cell 10A and the second fuel cell 10B, the same constituent elements as those of the fuel cell 10 are denoted by the same reference numerals. In particular, the configurations distinguished between the first fuel cell 10A and the second fuel cell 10B are suffixed with A or B.

The first fuel cell 10A includes a stack case 16A in which the fuel cell stack 14 (see FIG. 1) is mounted, and a hydrogen-system auxiliary device section 28A provided laterally adjacent to the first sidewall 161A of the stack case 16A.

The second fuel cell 10B includes a stack case 16B in which the fuel cell stack 14 (see FIG. 1) is mounted, and a hydrogen-system auxiliary device section 28B provided laterally adjacent to the first sidewall 161B of the stack case 16B.

The first fuel cell 10A and the second fuel cell 10B are arranged such that the first sidewall 161A and the first sidewall 161B face each other. Therefore, the hydrogen-system auxiliary device section 28A of the first fuel cell 10A and the hydrogen-system auxiliary device section 28B of the second fuel cell 10B are disposed so as to face each other.

The fuel cell system 50 of the present embodiment includes a hydrogen-capture hood 30A disposed so as to cover the hydrogen-system auxiliary device section 28A and the hydrogen-system auxiliary device section 28B from above. The hydrogen-capture hood 30A is arranged so as to bridge between the stack case 16A and the stack case 16B. A discharge hole 36 is provided at the end of the hydrogen-capture hood 30A in the width direction. The discharge hole 36 is positioned at the center of the hydrogen-capture hood 30A in the front-rear direction, and is apart from the upper end of the hydrogen-capture hood 30A. The discharge hole 36 is provided in common to the hydrogen-system auxiliary device section 28A and the hydrogen-system auxiliary device section 28B, and discharges hydrogen leaked from those sections.

A hydrogen sensor 38 is mounted on the hydrogen-capture hood 30A in the vicinity of the discharge hole 36. The hydrogen sensor 38 is attached to the inner side of the hydrogen-capture hood 30A, and is arranged in a manner not to protrude upward from the hydrogen-capture hood 30A. The hydrogen sensor 38 is disposed between the hydrogen-system auxiliary device section 28A and the hydrogen-system auxiliary device section 28B in the front-rear direction, and hydrogen leaking from both the sections can be efficiently detected by one hydrogen sensor 38.

The following supplementary notes are further disclosed in relation to the above embodiment.

### Supplementary Note 1

A fuel cell (10, 10A, 10B) of the present disclosure includes: a stack case (16, 16A, 16B) that houses a fuel cell stack (14); a hydrogen-system auxiliary device section (28, 28A, 28B) that is provided adjacent to the stack case and in which auxiliary devices configured to supply hydrogen to the fuel cell stack are collectively disposed; a hydrogen-capture hood (30, 30A) that is provided to cover an upper portion of the hydrogen-system auxiliary device section and that opens downward; and a hydrogen sensor (38) that is attached to the hydrogen-capture hood, wherein the hydrogen-capture hood includes an upper end wall (32) forming an uppermost portion (32a), a sidewall (34) extending downward from a peripheral edge of the upper end wall, and a discharge hole (36) disposed at the sidewall at a position separated downwardly from the upper end wall and configured to discharge hydrogen captured on an inner side ofthe sidewall, and wherein the hydrogen sensor is arranged inside the hydrogen-capture hood so as not to protrude above the upper end wall, and is positioned at a level higher than the discharge hole.

Even in the case where there is a spatial restriction in the upper portion, with the above-described fuel cell, the hydrogen sensor can be disposed at a position where hydrogen can be efficiently detected, and the above-described fuel cell makes it possible to reliably detect hydrogen leakage from the auxiliary devices without being largely constrained by installation location.

### Supplementary Note 2

In the fuel cell according to Supplementary Note 1, the hydrogen sensor may be arranged in the vicinity of the discharge hole. In the fuel cell, the hydrogen sensor can be arranged at a position where the hydrogen sensor can reliably detect leakage of hydrogen inside the hydrogen-capture hood.

### Supplementary Note 3

In the fuel cell according to Supplementary Note 1, the hydrogen-system auxiliary device section may be provided laterally adjacent to a first sidewall (161, 161A, 161B) of the stack case, the first sidewall of the stack case may include a ventilating unit (20) configured to discharge hydrogen leaked from the fuel cell stack, and the hydrogen-capture hood may cover the ventilating unit and the hydrogen-system auxiliary device section from above. In this fuel cell, the hydrogen sensor of the hydrogen-capture hood can detect hydrogen leaked from the fuel cell stack, and therefore the number of hydrogen sensors can be reduced.

### Supplementary Note 4

In the fuel cell according to Supplementary Note 3, the hydrogen sensor may be arranged between the ventilation unit and the discharge hole when viewed from above. The fuel cell prevents hydrogen discharged from the ventilation unit from being discharged from the discharge hole without coming into contact with the hydrogen sensor, and can reliably detect the hydrogen leaked from the ventilation unit by the hydrogen sensor.

### Supplementary Note 5

A fuel cell system (50) of the present disclosure includes two of the fuel cells (10) according to any one of Supplementary Note 1 to 4, wherein the hydrogen-system auxiliary device section of a first fuel cell (10A), which is one of the two of the fuel cells, and the hydrogen-system auxiliary device section of a second fuel cell (10B), which is another of the two of the fuel cells, are disposed so as to face each other, and the hydrogen-capture hood covers the hydrogen-system auxiliary device section of the first fuel cell and the hydrogen-system auxiliary device section of the second fuel cell from above. In this fuel cell system, since hydrogen leakage from two fuel cells can be detected by one hydrogen sensor, the number of expensive hydrogen sensors can be reduced.

Although concerning the present disclosure, a detailed description thereof has been presented above, the present

disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, these embodiments can also be implemented in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell comprising:
a stack case that houses a fuel cell stack;
a hydrogen-system auxiliary device section that is provided adjacent to the stack case and in which auxiliary devices configured to supply hydrogen to the fuel cell stack are collectively disposed;
a hydrogen-capture hood that is provided to cover an upper portion of the hydrogen-system auxiliary device section and that opens downward; and
a hydrogen sensor that is attached to the hydrogen-capture hood,
wherein the hydrogen-capture hood includes:
an upper end wall forming an uppermost portion;
a sidewall extending downward from a peripheral edge of the upper end wall;and
a discharge hole disposed at the sidewall at a position separated downwardly from the upper end wall and configured to discharge hydrogen captured on an inner side ofthe sidewall, and
wherein the hydrogen sensor is arranged inside the hydrogen-capture hood so as not to protrude above the upper end wall, and is positioned at a level higher than the discharge hole.

2. The fuel cell according to claim 1, whereinthe hydrogen sensor is arranged in avicinity of the discharge hole.

3. The fuel cell according to claim 1, wherein
the hydrogen-system auxiliary device section is provided laterally adjacent to a first sidewall of the stack case,
the first sidewall of the stack case includes a ventilating unit configured to discharge hydrogen leaked from the fuel cell stack, and
the hydrogen-capture hood covers the ventilating unit and the hydrogen-system auxiliary device section from above.

4. The fuel cell according to claim 3, whereinthe hydrogen sensor is arranged between the ventilation unit and the discharge hole when viewed from above.

5. A fuel cell system comprising two of the fuel cells according to claim 1, wherein
the hydrogen-system auxiliary device section of a first fuel cell, which is one of the two of the fuel cells, and the hydrogen-system auxiliary device section of a second fuel cell, which is another of the two of the fuel cells, are disposed so as to face each other, and
the hydrogen-capture hood covers the hydrogen-system auxiliary device section of the first fuel cell and the hydrogen-system auxiliary device section of the second fuel cell from above.
